(19) United States
(12) Patent Application Publication
(10) Pub. No.: US 2024/0262366 A1
(43) Pub. Date: Aug. 8, 2024

(54) VEHICLE BEHAVIOR PREDICTION APPARATUS AND VEHICLE BEHAVIOR PREDICTION METHOD

(71) Applicant: Mitsubishi Electric Corporation, Tokyo (JP)

(72) Inventors: Yuta TAKASHIMA, Tokyo (JP); Ryoma YATAKA, Tokyo (JP); Takuji MORIMOTO, Tokyo (JP); Tomoki UNO, Tokyo (JP); Taku UMEDA, Tokyo (JP)

(73) Assignee: Mitsubishi Electric Corporation, Tokyo (JP)

(21) Appl. No.: 18/537,194

(22) Filed: Dec. 12, 2023

(30) Foreign Application Priority Data
Feb. 8, 2023 (JP) 2023-017321

(51) Int. Cl. B60W 40/04; B60W 50/00

(52) U.S. Cl. CPC B60W 40/04; B60W 50/0097; B60W 2554/4041; B60W 2554/4045; B60W 2554/4046; B60W 2554/80

(57) ABSTRACT

To provide a vehicle behavior prediction apparatus and a vehicle behavior prediction method which can estimate a lane change destination position of the adjacent vehicle to an object lane considering an overlap degree between an object vehicle and an adjacent vehicle. A vehicle behavior prediction apparatus calculates an overlap degree between a position range of a prediction object vehicle and a position range of an object vehicle in a longitudinal direction, based on position information and shape information on the prediction object vehicle which is set from adjacent vehicles, and shape information on the object vehicle; and estimates a lane change destination position of the prediction object vehicle to the object lane, using a prediction model into which the position information and the speed information on the prediction object vehicle and the overlap degree is inputted.

### INCORPORATION BY REFERENCE

The disclosure of Japanese Patent Application No. 2023-017321 filed on Feb. 8, 2023 including its specification, claims and drawings, is incorporated herein by reference in its entirety.

### BACKGROUND

The present disclosure relates to a vehicle behavior prediction apparatus and a vehicle behavior prediction method.

The technology is proposed for estimating a lane change destination position, when an adjacent vehicle which is traveling in an adjacent lane adjacent to an ego lane where an ego vehicle is traveling changes lanes to the ego lane.

For example, the technology of patent document 1 supposes the first vehicle which is traveling in the front of the ego vehicle, and the second vehicle and the third vehicle which are traveling in the adjacent lane of the ego lane, and estimates a possibility that the third vehicle changes lanes to the ego lane considering the time to collision between the third vehicle and each of other vehicles.

The technology of nonpatent document 1 analyzes a danger factor at the time of merging using a canonical discrimination. It suggests that the potential collision danger at the time of merging increases, if the merging vehicle to the ego lane is a large size vehicle.

The technology of the nonpatent document 2 estimates an interruption position of the merging vehicle using a secondary discriminant analysis or a random forest, based on a vehicle head distance and a relative speed between the merging vehicle and a main lane traveling vehicle.
Patent document 1: JP 6494121 B

Nonpatent document 1: Koji SUZUKI, Yuki MATSUMURA, “A STUDY OF COLLISION RISK EVALUATION FOR NEAR-MISS EXPERIENCE AT MERGING SECTION OF URBAN EXPRESSWAY”, Journal of Japan Society of Civil Engineers, Ser. D3 (Infrastructure Planning and Management), Volume 71, Issue 5, 2015

Nonpatent document 2: Koji Tanida, Masahiro Kimura, Yuichi Yoshida, “Modeling of Expressway Merging Behavior for Autonomous Vehicle Control”, Transactions of Society of Automotive Engineers of Japan, Volume 48, Issue 4, 2017

### SUMMARY

However, as a result of study of inventor, it was found that, even if a positional relationship between a representative position of the ego vehicle and a representative position of the adjacent vehicle is the same, a lane change destination position of the adjacent vehicle is changed according to an overlap degrees between a position range of the ego vehicle and a position range of the adjacent vehicle in a longitudinal direction, and it is important to use the overlap degree for prediction. This overlap degree is changed variously according to the representative position of each vehicle, and the vehicle length of each vehicle. If the lane change destination position of the adjacent vehicle is estimated using the representative position of each vehicle, and the vehicle length of each vehicle, without using the overlap degree, a number of input parameters required for prediction increases, the prediction model becomes complex, and the processing load using the prediction model increases. The indirect parameters may not sufficiently express the overlap degree, and prediction accuracy decreases. Each of above documents does not disclose about estimation of the lane change destination position using the overlap degree.

Then, the purpose of the present disclosure is to provide a vehicle behavior prediction apparatus and a vehicle behavior prediction method which can estimate a lane change destination position of the adjacent vehicle to an object lane considering an overlap degree between an object vehicle and an adjacent vehicle.

A vehicle behavior prediction apparatus according to present disclosure, including:
an information acquisition unit that acquires a periphery state of an object vehicle and a vehicle state of the object vehicle, and acquires position information, speed information, and shape information on one or more adjacent vehicles which travel in an adjacent lane adjacent to an object lane where the object vehicle is traveling, based on the periphery state and the vehicle state of the object vehicle;
a prediction object setting unit that sets a prediction object vehicle from the one or more adjacent vehicles;
a feature amount calculation unit that calculates an overlap degree between a position range of the prediction object vehicle and a position range of the object vehicle in a longitudinal direction, based on the position information and the shape information on the prediction object vehicle, and shape information included in the vehicle state of the object vehicle; and a lane change prediction unit that estimates a lane change destination position of the prediction object vehicle to the object lane, using a prediction model into which at least one of the position information and the speed information on the prediction object vehicle, and the overlap degree between the object vehicle and the prediction object vehicle are inputted.

A vehicle behavior prediction method according to the present disclosure, including:
an information acquisition step of acquiring a periphery state of an object vehicle and a vehicle state of the object vehicle, and acquiring position information, speed information, and shape information on one or more adjacent vehicles which travel in an adjacent lane adjacent to an object lane where the object vehicle is traveling, based on the periphery state and the vehicle state of the object vehicle;
a prediction object setting step of setting a prediction object vehicle from the one or more adjacent vehicles;
a feature amount calculation step of calculating an overlap degree between a position range of the prediction object vehicle and a position range of the object vehicle in a longitudinal direction, based on the position information and the shape information on the prediction object vehicle, and shape information included in the vehicle state of the object vehicle; and
a lane change prediction step of estimating a lane change destination position of the prediction object vehicle to the object lane, using a prediction model into which at least one of the position information and the speed information on the prediction object vehicle, and the overlap degree between the object vehicle and the prediction object vehicle are inputted.

Even if the relative position and the relative speed of the prediction object vehicle with respect to the object vehicle is the same, the lane change destination position of the prediction object vehicle is changed by a change of the overlap degree between the object vehicle and the prediction object vehicle. Accordingly, by the overlap degree between the object vehicle and the prediction object vehicle, the feature of the change of the lane change destination position can be captured. Since the lane change destination position of the prediction object vehicle is estimated using the prediction model into which the overlap degree between the object vehicle and the prediction object vehicle is inputted in addition to one of the position information and the speed information on the prediction object vehicle, prediction accuracy can be improved. Since the overlap degree is inputted directly, compared with a case where a plurality of other parameters related to the overlap degree are inputted, the number of input parameters required for prediction can be decreased, the prediction model can be simplified, and the processing load using the prediction model can be decreased. Compared with the case where the indirect parameters related to the overlap degree are inputted, prediction accuracy can be improved.

### BRIEF DESCRIPTION OF THE DRAWINGS

FIG. 1 is a schematic block diagram of the vehicle behavior prediction apparatus and the driving support apparatus according to Embodiment 1;

FIG. 2 is a schematic hardware configuration figure of the vehicle behavior prediction apparatus according to Embodiment 1;

FIG. 3 is a schematic hardware configuration figure of the vehicle behavior prediction apparatus according to Embodiment 1;

FIG. 4 is a figure for explaining the ego vehicle coordinate system according to Embodiment 1;

FIG. 5 is a figure for explaining calculation of the overlap degree between the prediction object vehicle and the ego vehicle according to Embodiment 1;

FIG. 6 is a figure for explaining the change of the lane change destination by the change of the overlap degree according to Embodiment 1;

FIG. 7 is a figure for explaining the change of the lane change destination by the change of the overlap degree according to Embodiment 1;

FIG. 8 is a figure for explaining the change of the lane change destination by the change of the overlap degree according to Embodiment 1;

FIG. 9 is a figure for explaining the change of the lane change destination by the change of the overlap degree according to Embodiment 1;

FIG. 10 is a figure for explaining setting of the overlap degree in case of the complete inclusion according to Embodiment 1;

FIG. 11 is a figure for explaining setting of the overlap degree in case of the complete inclusion according to Embodiment 1;

FIG. 12 is a figure for explaining calculation of the overlap degree considered the safe distance according to Embodiment 1;

FIG. 13 is a figure for explaining calculation of the overlap degree between each of the preceding vehicle and the following vehicle of the ego vehicle, and the prediction object vehicle according to Embodiment 1;

FIG. 14 is a figure for explaining calculation of the overlap degree by the probability distribution according to Embodiment 1;

FIG. 15 is a figure for explaining calculation of the feature amount regarding the intimidating feeling according to Embodiment 1;

FIG. 16 is a figure for explaining the rule base model as the prediction model according to Embodiment 1;

FIG. 17 is a figure for explaining calculation of the collision possibility degree between each of the preceding vehicle and the following vehicle of the prediction object vehicle, and the prediction object vehicle according to Embodiment 2;

FIG. 18 is a figure for explaining calculation of the remaining time until the forcible merging start according to Embodiment 2;

FIG. 19 is a flowchart for explaining processing of the vehicle behavior prediction apparatus according to Embodiment 1; and

FIG. 20 is a schematic block diagram of the vehicle behavior prediction apparatus according to Embodiment 1.

### DETAILED DESCRIPTION OF THE EMBODIMENTS

### 1. Embodiment 1

A vehicle behavior prediction apparatus 1 according to Embodiment 1 will be explained with reference to drawings. In the present embodiment, an object vehicle is set to an ego vehicle which is a vehicle mounting the vehicle behavior prediction apparatus 1. And, an object lane where the object vehicle is traveling is referred to as an ego lane. The vehicle behavior prediction apparatus 1 is embedded in a driving support apparatus 50. The driving support apparatus 50 is provided in the ego vehicle.

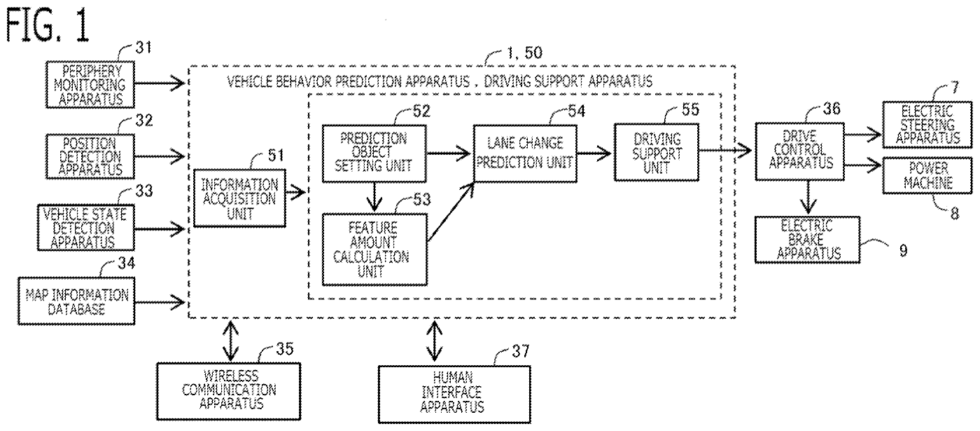

As shown in FIG. 1, the ego vehicle is provided with a periphery monitoring apparatus 31, a position detection apparatus 32, a vehicle state detection apparatus 33, a map information database 34, a wireless communication apparatus 35, a driving support apparatus 50, a drive control apparatus 36, a power machine 8, an electric steering apparatus 7, an electric brake apparatus 9, a human interface apparatus 37, and the like.

The periphery monitoring apparatus 31 is an apparatus which monitors the periphery of vehicle, such as a camera and a radar. As the radar, a millimeter wave radar, a laser radar, an ultrasonic radar, and the like are used. The wireless communication apparatus 35 performs a wireless communication with a base station, using the wireless communication standard of cellular communication system, such as 4G and 5G.

The position detecting apparatus 32 is an apparatus which detects the current position (latitude, longitude, altitude) of the ego vehicle, and a GPS antenna which receives the signal outputted from satellites, such as GNSS (Global Navigation Satellite System), is used. For detection of the current position of the ego vehicle, various kinds of methods, such as the method using the traveling lane identification number of the ego vehicle, the map matching method, the dead reckoning method, and the method using the detection information around the ego vehicle, may be used.

In the map information database 34, road information, such as a road shape (for example, a lane number, a position of each lane, a shape of each lane, a type of each lane, a road type, a limit speed, and the like), a sign, and a road signal, is stored. The map information database 34 is mainly constituted of a storage apparatus. The map information database 34 may be provided in a server outside the vehicle connected to the network, and the driving support apparatus 50 may acquire required road information from the server outside the vehicle via the wireless communication apparatus 35.

As the drive control apparatus 36, a power controller, a brake controller, an automatic steering controller, a light controller, and the like are provided. The power controller controls output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

The vehicle condition detection apparatus 33 is a detection apparatus which detects an ego vehicle state which is a driving state and a traveling state of the ego vehicle. In the present embodiment, the vehicle state detection apparatus 33 detects a speed, an acceleration, a yaw rate, a steering angle, a lateral acceleration and the like of the ego vehicle, as the traveling state of the ego vehicle. For example, as the vehicle state detection apparatus 33, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 33, an accelerator position sensor, a brake position sensor, a steering angle sensor (handle angle sensor), a steering torque sensor, a direction indicator position switch, and the like are provided.

The human interface apparatus 37 is an apparatus which receives input of the driver or transmits information to the driver, such as a loudspeaker, a display screen, an input device, and the like.

### 1-1. Driving Support Apparatus 50 (Vehicle Behavior Prediction Apparatus 1)

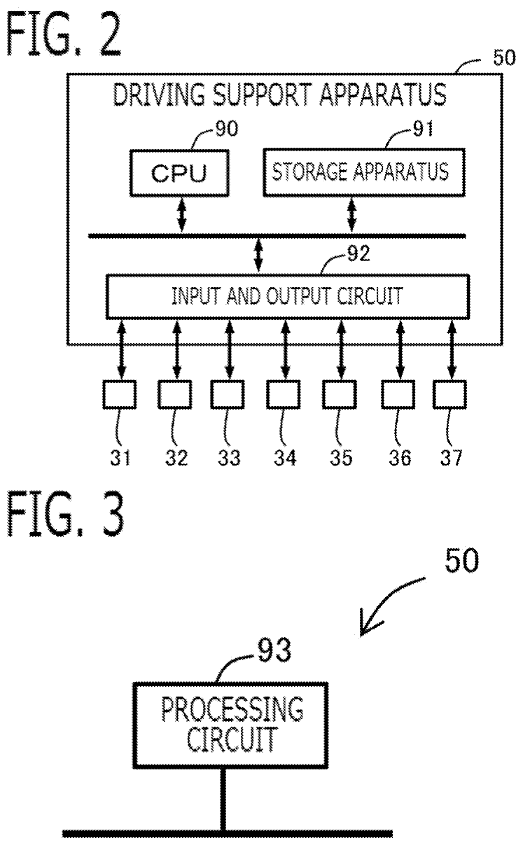

The driving support apparatus 50 (the vehicle behavior prediction apparatus 1) is provided with functional units, such as an information acquisition unit 51, a prediction object setting unit 52, a feature amount calculation unit 53, a lane change prediction unit 54, and a driving support unit 55. Each function of the driving support apparatus 50 is realized by processing circuits provided in the driving support apparatus 50. As shown in FIG. 2, specifically, the driving support apparatus 50 is provided with an arithmetic processor 90 such as CPU (Central Processing Unit), storage apparatuses 91, an input and output circuit 92 which outputs and inputs external signals to the arithmetic 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle state detection apparatus 33, the map information database 34, the wireless communication apparatus 35, the drive control apparatus 36, and the human interface apparatus 37, and communicates with these devices.

Then, the arithmetic processor 90 runs software items (programs) stored in the storage apparatus 91 and collaborates with other hardware devices in the driving support apparatus 50, such as the storage apparatus 91, and the input and output circuit 92, so that the respective functions of the functional units 51 to 55 provided in the driving support apparatus 50 are realized. Setting data, such as a speed increase amount, utilized in the functional units 51 to 55 are stored in the storage apparatus 91, such as EEPROM.

Alternatively, as shown in FIG. 3, the driving support apparatus 50 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the driving support apparatus 50 will be described in detail below.

### 1-1-1. Information Acquisition Unit 51

### <Acquisition of Periphery State of Ego Vehicle, and Traveling State of Ego Vehicle>

The information acquisition unit 51 acquires a periphery state of the ego vehicle, and a vehicle state of the ego vehicle. The vehicle state of the ego vehicle includes a traveling state and shape information on the ego vehicle. In the present embodiment, state of the ego vehicle, the information acquisition unit 51 acquires a position, a moving direction, a speed, an acceleration, a presence or absence of lane change, and the like of the ego vehicle, based on the position information on the ego vehicle acquired from the position detection apparatus 32, and the ego vehicle state acquired from the vehicle state detection apparatus 33. The information acquisition unit 51 acquires preliminarily set vehicle information on the ego vehicle (a vehicle type, shape information, and the like) from the storage apparatus and the like.

As the periphery state of the ego vehicle, the information acquisition unit 51 acquires a traveling state and vehicle information of a peripheral vehicle which exists around the ego vehicle. In the present embodiment, the information acquisition unit 51 acquires a position, a moving direction, a speed, an acceleration, an operating condition of the direction indicator, and the like of the peripheral vehicle, based on the detection information acquired from the periphery monitoring apparatus 31, and the position information on the ego vehicle acquired from the position detection apparatus 32. The information acquisition unit 51 also acquires information on an obstacle, a pedestrian, a sign, a traffic regulation such as lane regulation, and the like, other than the peripheral vehicle. As the vehicle information on the peripheral vehicle, the information acquisition unit 51 acquires a vehicle type of the peripheral vehicle (for example, a light duty vehicle, a minicar, a medium duty vehicle, a medium duty track, a heavy duty truck, a medium duty trailer, a heavy duty trailer, an ambulance, a police car, a two-wheeled vehicle, various kinds of special vehicles, and the like), and shape information (for example, a vehicle length, a vehicle width, a vehicle height, and the like), based on the detection information acquired from the periphery monitoring apparatus 31 and the like. The information acquisition unit 51 also acquires information on reliability of each acquired information on the peripheral vehicle and the like.

The information acquisition unit 51 can acquire the traveling state of the peripheral vehicle, the lane information on the peripheral vehicle, and the vehicle information on the peripheral vehicle (the vehicle type, shape information, and the like) from the outside of the ego vehicle by communication. For example, the information acquisition unit 51 may acquire the traveling state of the peripheral vehicle (the position, the moving direction, the speed, the operation state of the direction indicator, a target traveling trajectory, and the like of the peripheral vehicle) from the peripheral vehicle by the wireless communication and the like. From a roadside machine, such as a camera which monitors the condition of road, the information acquisition unit 51 may acquire the traveling state of the peripheral vehicle which exists in a monitor area (the position, the moving direction, the speed, the acceleration, the operation state of the direction indicator, and the like of the peripheral vehicle), vehicle information (the vehicle type, the shape information, and the like), information on an obstacle, a pedestrian, and the like, a road shape, a traffic regulation, a traffic state, and the like, by the wireless communication and the like.

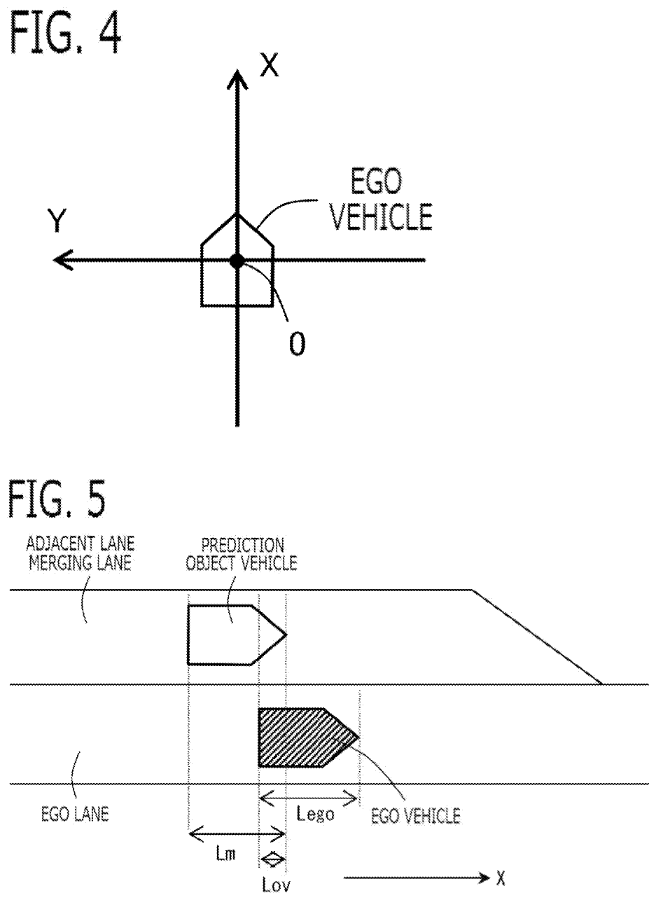

In the present embodiment, the information acquisition unit 51 acquires a relative position and a relative speed of the peripheral vehicle and the like with respect to the ego vehicle in an ego vehicle coordinate system on the basis of the current position of the ego vehicle. As shown in FIG. 4, the ego vehicle coordinate system is a coordinate system which has two axes of a longitudinal direction X and a lateral direction Y of the present ego vehicle. The information acquisition unit 51 may acquire the relative position and the relative speed of the peripheral vehicle in a coordinate system of a longitudinal direction and a lateral direction of the ego lane where the ego vehicle is traveling. The information acquisition unit 51 may acquire an absolute position (latitude, longitude), an absolute moving direction (azimuth), an absolute speed, an absolute acceleration, and the like of each vehicle.

As the periphery state of the ego vehicle, the information acquisition unit 51 acquires road information around the ego vehicle from the map information database 34, based on the position information on the ego vehicle acquired from the position detection apparatus 32. The acquired road information includes the lane number, the position of each lane, the shape of each lane, the type of each lane, the road type, the limit speed, and the like. The shape of each lane includes the position of lane, the curvature of lane, the longitudinal slope of lane, the cross slope of lane, the width of lane, and the like. The shape of lane is set at each point along the longitudinal direction of the lane. The type of each lane includes a merging lane, a main lane into which the merging lane merges, and the like. The shape of lane includes a merging start possible position where a start of the merging into the main lane becomes possible in the merging lane, and an end position of the merging lane. The information acquisition unit 51 acquires information on traffic regulation, such as a lane regulation due to construction, from the external server and the like.

The information acquisition unit 51 detects a shape and a type of a lane marking and the like of the road, based on the detection information on the lane marking, such as a white line and a road shoulder, acquired from the periphery monitoring apparatus 31; and determines the shape and the position of each lane, the lane number, the type of each lane, and the like, based on the detected shape and the detected type of the lane marking of the road.

The information acquisition unit 51 acquires the lane information corresponding to an ego lane where the ego vehicle is traveling, based on the position of the ego vehicle. The information acquisition unit 51 acquires the lane information corresponding to a lane where each peripheral vehicle is traveling, based on the position of each peripheral vehicle. The acquired lane information includes the shape, the position, and the type of lane, and the lane information on the peripheral lane.

### <Information Acquisition of Adjacent Vehicle>

The information acquisition unit 51 acquires position information, speed information, and shape information (a vehicle length, a vehicle width, a vehicle height, and the like) on one or more adjacent vehicles which travel in an adjacent lane adjacent to an ego lane where the ego vehicle is traveling, based on the periphery state of the ego vehicle and the traveling state of the ego vehicle which were acquired. When a plurality of adjacent vehicles exist, the information on each adjacent vehicle is acquired.

The information acquisition unit 51 determines the ego lane where the ego vehicle is traveling, based on the position of the ego vehicle and road information (position and shape of each lane, and the like), and determines the adjacent lane of the ego lane, based on the information on the determined ego lane and the road information. The adjacent lane includes one or both of the left side lane and the right side lane of the ego lane with the same traveling direction as the ego vehicle. The information acquisition unit 51 determines the adjacent vehicle which is the peripheral vehicle traveling in the adjacent lane, based on the information on the determined adjacent lane, and the traveling state of the peripheral vehicle.

The position information on the adjacent vehicle includes the relative position of the adjacent vehicle with respect to the ego vehicle. The speed information on the adjacent vehicle includes the relative speed of the adjacent vehicle with respect to the ego vehicle. As mentioned above, the relative position and the relative speed of the adjacent vehicle may be acquired in the ego vehicle coordinate system (the longitudinal direction and the lateral direction of the ego vehicle), or may be acquired in the coordinate system of the ego lane (the longitudinal direction and the lateral direction of the ego lane).

The position of each vehicle may be set to a center position of each vehicle, may be set to a front end position of each vehicle, or may be set to a rear end position of each vehicle. The position of the ego vehicle may be set to the front end position, and the position of the adjacent vehicle may be set to the rear end position. Conversely, the position of the ego vehicle may be set to the rear end position, and the position of the adjacent vehicle may be set to the front end position. A vehicle distance in the longitudinal direction may be acquired as the relative position.

The information acquisition unit 51 acquires the position information (the relative position and the like), the speed information (the relative speed and the like), and the shape information (the vehicle length, the vehicle width, the vehicle height, and the like) on each of a preceding vehicle and a following vehicle which are traveling in the ego lane in front of and in back of the ego vehicle, based on the periphery state of the ego vehicle, and the traveling state of the ego vehicle. When the preceding vehicle of the ego vehicle does not exist, the information on the preceding vehicle is not acquired, and when the following vehicle of the ego vehicle does not exist, the information on the following vehicle is not acquired.

The information acquisition unit 51 acquires the position information (the relative position and the like), the speed information (the relative speed and the like), and the shape information (the vehicle length, the vehicle width, the vehicle height, and the like) on each of a preceding vehicle and a following vehicle which are traveling in the adjacent lane in front of and in back of the prediction object vehicle, based on the periphery state of the ego vehicle, and the vehicle state (for example, traveling state) of the ego vehicle. When the preceding vehicle of the prediction object vehicle does not exist, the information on the preceding vehicle is not acquired, and when the following vehicle of the prediction object vehicle does not exist, the information on the following vehicle is not acquired.

The information acquisition unit 51 calculates the relative position and the relative speed of each of the preceding vehicle and the following vehicle with respect to the prediction object vehicle, based on the position information and the speed information on the prediction object vehicle, the position information and the speed information on each of the preceding vehicle and the following vehicle of the prediction object vehicle.

### <Setting of Vehicle Length of Prediction Object Vehicle>

The information acquisition unit 51 acquires the vehicle type of the prediction object vehicle and the vehicle length Lm of the prediction object vehicle from the periphery monitoring apparatus 31 and the like. And, when a difference between the acquired vehicle length Lm of the prediction object vehicle and a vehicle length Lmest estimated from the vehicle type of the prediction object vehicle is greater than or equal to a determination value, the information acquisition unit 51 sets the vehicle length Lmest estimated from the vehicle type of the prediction object vehicle as a formal vehicle length Lm of the prediction object vehicle used for calculation of the overlap degree. On the other hand, when the difference is less than the determination value, the information acquisition unit 51 sets the vehicle length Lm of the prediction object vehicle acquired from the periphery monitoring apparatus 31 and the like as the formal vehicle length Lm of the prediction object vehicle used for calculation of the overlap degree.

A recognition error of the vehicle length Lm of the prediction object vehicle acquired from the periphery monitoring apparatus 31 and the like may be large. According to the above configuration, by comparing the acquired vehicle length Lm with the vehicle length Lmest estimated from the vehicle type, when the recognition error of the acquired vehicle length Lm is large, the vehicle length Lmest estimated from the vehicle type can be used. An error of the vehicle length Lm of the prediction object vehicle used for calculation of the overlap degree can be reduced.

### 1-1-2. Prediction Object Setting Unit 52

The prediction object setting unit 52 sets the prediction object vehicle from one or more the adjacent vehicles. The prediction object setting unit 52 determines whether or not there is a possibility that the adjacent vehicle changes lanes from the adjacent lane to the ego lane; and sets the adjacent vehicle which is determined that there is the possibility to change lanes, as a prediction object vehicle. When a plurality of prediction object vehicles are set, the prediction processing is performed about each prediction object vehicle.

The prediction object setting unit 52 determines whether or not there is the possibility that the adjacent vehicle changes lanes to the ego lane, based on the traveling state of the adjacent vehicle, the periphery state of the adjacent vehicle, and the like. For example, the prediction object setting unit 52 determines that there is the possibility to change lanes, when the adjacent lane where the adjacent vehicle is traveling is a merging lane which merges into the ego lane. The prediction object setting unit 52 determines that there is the possibility to change lanes, when the adjacent vehicle is operating the direction indicator to the side of the ego lane. The prediction object setting unit 52 determines that there is the possibility to change lanes, when information of changing lanes to the ego lane is transmitted from the adjacent vehicle by the wireless communication. The prediction object setting unit 52 determines whether or not there is the possibility to change lanes, based on the relative speed and the relative position in the lateral direction of the adjacent vehicle.

### 1-1-3. Feature Amount Calculation Unit 53

The feature amount calculation unit 53 calculates an overlap degree IoU between the position range of the prediction object vehicle and the position range of the ego vehicle in the longitudinal direction X, based on the position information and the shape information on the prediction object vehicle, and the shape information on the ego vehicle. The longitudinal direction X may be the longitudinal direction of the ego vehicle, or may be the longitudinal direction of the ego lane.

As shown in FIG. 5, the feature amount calculation unit 53 calculates an overlap length Lov of position range where the position range of the prediction object vehicle and the position range of the ego vehicle overlap in the longitudinal direction X, based on the relative position of the prediction object vehicle in the longitudinal direction X with respect to the ego vehicle, the vehicle length Lm of the prediction object vehicle, and the vehicle length Lego of the ego vehicle. When not overlapping, the overlap length Lov becomes 0. The position range of the prediction object vehicle is set, based on the position information and the shape information on the prediction object vehicle which were acquired by the information acquisition unit 51. For example, the position range of the prediction object vehicle may be set to a position range in the longitudinal direction X where the prediction object vehicle was recognized, or may be set based on the representative position and the vehicle length of the prediction object vehicle.

In the present embodiment, the feature amount calculation unit 53 calculates the overlap degree IoU, based on the overlap length Lov, and a length of an union of the position range of the prediction object vehicle and the position range of the ego vehicle in the longitudinal direction X. For example, as shown in the next equation, the feature amount calculation unit 53 calculates a value obtained by dividing the overlap length Lov by the length of the union, as the overlap degree IoU. This overlap degree IoU is IoU (Intersection over Union), and becomes a value obtained by dividing an intersection of two regions by an union. When not overlapping, the overlap degree IoU becomes 0.

$$IoU = Lov / ( Lm + Lego - Lov ) \qquad ( 1 )$$

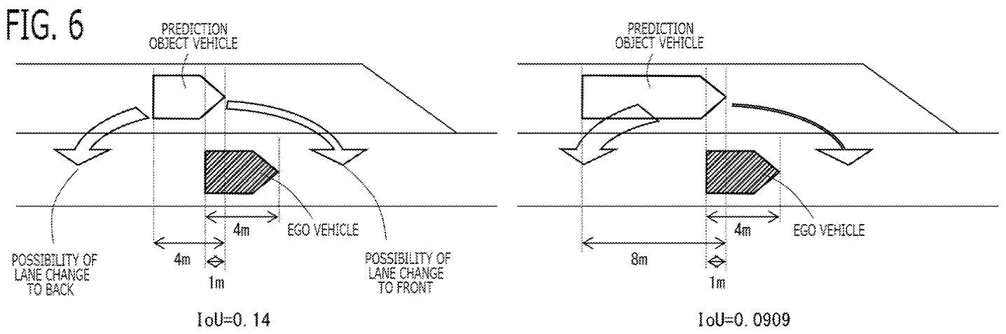

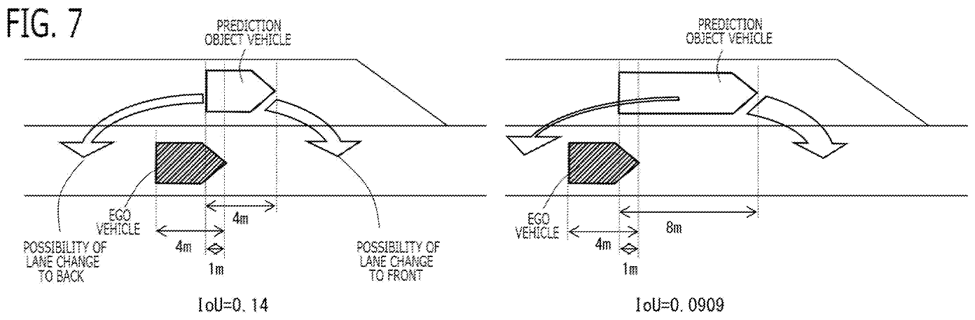

By using this overlap degree IoU, as shown in FIG. 6 and FIG. 7, even if the overlap length Lov is the same, as the vehicle length Lm of the prediction object vehicle with respect to the vehicle length Lego of the ego vehicle becomes long, the overlap degree IoU becomes small. As shown in FIG. 6, when the prediction object vehicle is positioned in back of the ego vehicle, as the vehicle length Lm of the prediction object vehicle with respect to the vehicle length Lego of the ego vehicle becomes long, a possibility that the prediction object vehicle changes lanes to the back of the ego vehicle becomes high. On the other hand, as shown in FIG. 7, when the prediction object vehicle is positioned in front of the ego vehicle, as the vehicle length Lm of the prediction object vehicle with respect to the vehicle length Lego of the ego vehicle becomes long, a possibility that the prediction object vehicle changes lanes to the front of the ego vehicle becomes high. Therefore, by the overlap degree IoU, even if the overlap length Lov is the same, it is possible to capture a feature of a change in the lane change destination position according to a change in the vehicle length Lm of the prediction object vehicle with respect to the vehicle length Lego of the ego vehicle.

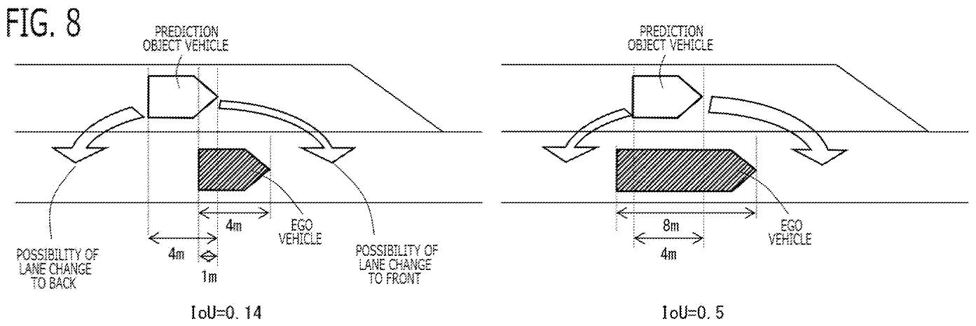

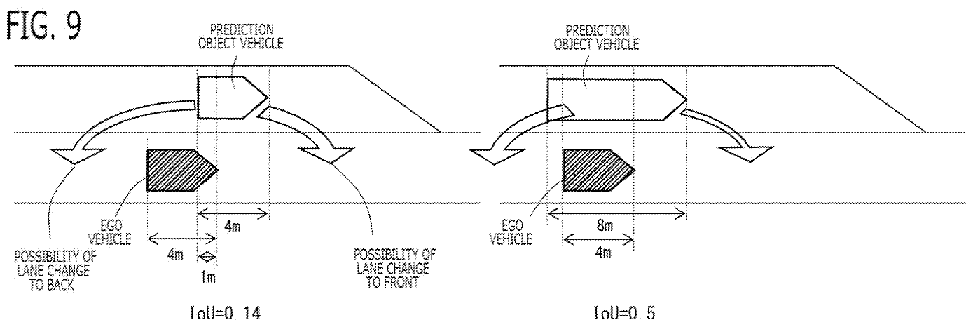

As shown in FIG. 8, when the prediction object vehicle is positioned in back of the ego vehicle, even if a distance between the front end of the prediction object vehicle and the front end of the ego vehicle in the longitudinal direction X is the same, as the vehicle length Lm of the prediction object vehicle with respect to the vehicle length Lego of the ego vehicle becomes short, the overlap degree IoU becomes large. As the vehicle length Lm of the prediction object vehicle with respect to the vehicle length Lego of the ego vehicle becomes short, a possibility that the prediction object vehicle changes lanes to the back of the ego vehicle becomes low. On the other hand, as shown in FIG. 9, when the prediction object vehicle is positioned in front of the ego vehicle, even if the distance between the front end of the prediction object vehicle and the front end of the ego vehicle in the longitudinal direction X is the same, as the vehicle length Lm of the prediction object vehicle with respect to the vehicle length Lego of the ego vehicle becomes long, the overlap degree IoU becomes large. As the vehicle length Lm of the prediction object vehicle with respect to the vehicle length Lego of the ego vehicle becomes long, the possibility that the prediction object vehicle changes lanes to the front of the ego vehicle becomes low. Therefore, by the overlap degree IoU, even if the distance between the front end of the prediction object vehicle and the front end of the ego vehicle is the same, it is possible to capture the feature of the change in the lane change destination position according to the change in the vehicle length Lm of the prediction object vehicle with respect to the vehicle length Lego of the ego vehicle.

Alternatively, the feature amount calculation unit 53 may calculate the overlap degree IoU, based on the overlap length Lov and the vehicle length Lm of the prediction object vehicle. For example, the feature amount calculation unit 53 may calculate a value obtained by dividing the overlap length Lov by the vehicle length Lm of the prediction object vehicle, as the overlap degree IoU. Since the vehicle length Lego of the ego vehicle does not change by this calculation, it is possible to capture the feature of the change in the lane change destination position according to the change in the vehicle length Lm of the prediction object vehicle with respect to the vehicle length Lego of the ego vehicle.

Alternatively, the feature amount calculation unit 53 may calculate the overlap degree IoU, based on the overlap length Lov and the vehicle length Lego of the ego vehicle. For example, the feature amount calculation unit 53 may calculate a value obtained by dividing the overlap length Lov by the vehicle length Lego of the ego vehicle, as the overlap degree IoU. Also by this calculation, when the vehicle length Lego of the ego vehicle is long, the feature of the change in the lane change destination position can be captured.

### <In Case of Complete Inclusion>

The feature amount calculation unit 53 may set the overlap degree IoU to a preliminarily set value (for example, 1), when the position range of the prediction object vehicle completely includes the position range of the ego vehicle in the longitudinal direction X, or when the position range of the ego vehicle completely includes the position range of the prediction object vehicle in the longitudinal direction X.
1) In case of Lov=Lego or Lov=Lm, IoU=1
2) In other cases,

$$IoU = Lov / ( Lm + Lego - Lov ) \qquad ( 2 )$$

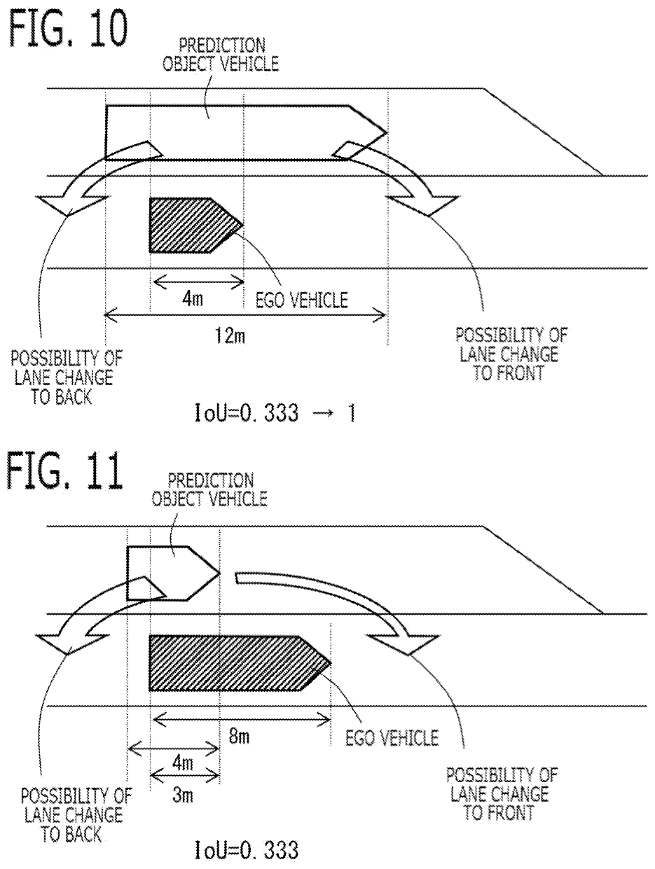

In FIG. 10 and FIG. 11, the overlap degrees IoU calculated by the equation (1) are the same values. But, in FIG. 11 which is not a case of the complete inclusion, the possibility that the prediction object vehicle changes lanes to the back of the ego vehicle becomes higher. Accordingly, in the case where one of the ego vehicle and the prediction object vehicle is extremely long and the case of the complete inclusion, the feature of the change of the lane change destination position can be captured by setting the overlap degree IoU to the predetermined value.

### <Increase in Vehicle Length for Safe Distance>

The feature amount calculation unit 53 may virtually increase the position range and the vehicle length of one or both of the ego vehicle and the prediction object vehicle which are used for calculation of the overlap degree IoU, based on a safe distance Lsf to be secured at minimum in front and back of vehicle.

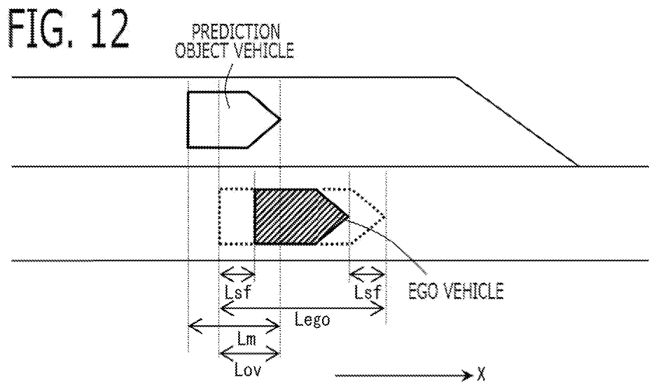

FIG. 12 shows a case where the position range and the vehicle length Lego of the ego vehicle are increased according to the safe distance Lsf. The safe distance Lsf is added in front and back of the actual position range of the ego vehicle, and the vehicle length Lego becomes long by the safe distances Lsf in front and back. The overlap length Lov is calculated based on the position range of the ego vehicle after the addition of the safe distance Lsf. The overlap degree IoU is calculated based on the vehicle length Lego of the ego vehicle after the addition of the safe distance Lsf.

The position range and the vehicle length Im of the prediction object vehicle may be increased by the safe distance Lsf. The safe distance Lsf in front of vehicle may be different from the safe distance Lsf in back of vehicle. For example, the safe distance Lsf in front may become longer than the safe distance Lsf in back. The safe distances Lsf which are set in front or back of each vehicle may be set to predetermined values, may be changed according to the vehicle type of each vehicle, or may be changed according to each vehicle speed.

Generally, when the driver or the automatic driving apparatus determines the lane change destination, the safe distance Lsf in front and back of vehicle is also considered. According to the above configuration, by also considering the safe distance Lsf for calculation of the overlap degree IoU, the feature of the lane change destination position can be captured with better accuracy.

### <Calculation of Overlap Degree Between Prediction Object Vehicle, and Each of Preceding Vehicle and Following Vehicle>

The feature amount calculation unit 53 may calculate an overlap degree between the position range of the prediction object vehicle in the longitudinal direction X, and the position range of each of the preceding vehicle and the following vehicle of the ego vehicle, based on the position information and the shape information on the prediction object vehicle, and the position information and the shape information on each of the preceding vehicle and the following vehicle of the ego vehicle.

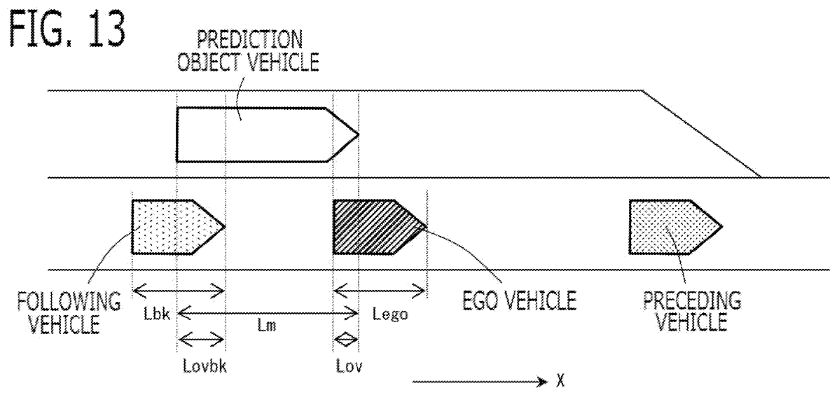

FIG. 13 shows an example of calculation of the overlap degree IoUbk between the prediction object vehicle and the following vehicle. When the position range of the prediction object vehicle overlaps not only with the position range of the ego vehicle but also with the position range of the following vehicle, there is not sufficient space where the prediction object vehicle changes lanes between the ego vehicle and the following vehicle. Accordingly, even if the overlap degree IoU between the prediction object vehicle and the ego vehicle is the same, as the overlap degree IoUbk between the prediction object vehicle and the following vehicle becomes large, the possibility that the prediction object vehicle changes lanes to the back of the ego vehicle becomes low. Therefore, by the overlap degree IoUbk between the prediction object vehicle and the following vehicle, the feature of the lane change destination position of the prediction object vehicle can be captured. The same is applied to the overlap degree IoUfr between the prediction object vehicle and the preceding vehicle.

By a method similar to calculation of the overlap degree IoU between the prediction object vehicle and the ego vehicle, the feature amount calculation unit 53 calculates the overlap degree IoUbk between the prediction object vehicle and the following vehicle, and the overlap degree IoUfr between the prediction object vehicle and the preceding vehicle. Herein, Lovbk is an overlap length of position range where the position range of the prediction object vehicle and the position range of the following vehicle overlap in the longitudinal direction X. Lbk is the vehicle length of the following vehicle. Lovfr is an overlap length of position range where the position range of the prediction object vehicle and the position range of the preceding vehicle overlap in the longitudinal direction X. Lfr is the vehicle length of the preceding vehicle.

$$IoUbk = Lovbk / ( Lm + Lbk - Lovbk ) \qquad ( 3 )$$

$$IoUfr = Lovfr / ( Lm + Lfr - Lovfr )$$

When the prediction object vehicle and the following vehicle do not overlap, or when the following vehicle does not exist, Lovbk becomes 0. When the prediction object vehicle and the preceding vehicle do not overlap, or when the preceding vehicle does not exist, Lovfr becomes 0. The safe distance Lsf mentioned above may be considered in the calculation of Lovbk and Lovfr.

### <Calculation of Overlap Degree by Probability Distribution>

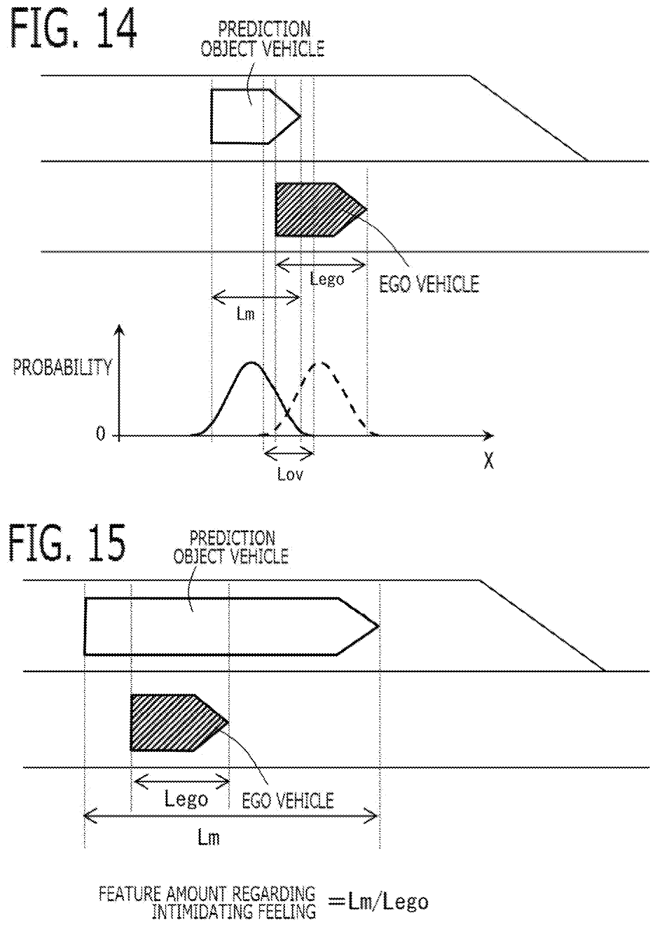

As shown in FIG. 14, the feature amount calculation unit 53 may calculate a probability distribution of presence of the prediction object vehicle with respect to the longitudinal direction X, as the position range of the prediction object vehicle; may calculate a probability distribution of presence of the ego vehicle with respect to the longitudinal direction X, as the position range of the ego vehicle; and may calculate the overlap degree, based on an overlap degree between the probability distribution of the prediction object vehicle, and the probability distribution of the ego vehicle.

There is a recognition error in the position information and the shape information on the prediction object vehicle. By calculating the overlap degree of probability distribution, the overlap degree in which the recognition error is considered can be calculated.

The probability distribution is set, based on the position range of each vehicle acquired as mentioned above, and a variance or a standard deviation in which the recognition error is considered. For example, the feature amount calculation unit 53 generates a probability distribution which expresses a predetermined variance or a predetermined standard deviation and is non-dimensionalized in the longitudinal direction X; and generates the probability distribution of each vehicle by multiplying the length of the position range of each vehicle to the non-dimensionalized longitudinal direction X. A center position of the probability distribution in the longitudinal direction X is set to a center position of each vehicle in the longitudinal direction X. The variance or the standard deviation of each vehicle may be changed according to a reliability of the position range of each vehicle acquired by the information acquisition unit 51.

For example, the feature amount calculation unit 53 calculates an overlap length Lov of position range where a position range where the probability distribution of the prediction object vehicle becomes a predetermined value or more, and a position range where the probability distribution of the ego vehicle becomes the predetermined value or more overlap in the longitudinal direction X. Then, the feature amount calculation unit 53 calculates the overlap degree IoU using the equation (1). As the length of the union, a length of an union of the position range where the probability distribution of the prediction object vehicle becomes the predetermined value or more, and the position range where the probability distribution of the ego vehicle becomes the predetermined value or more in the longitudinal direction X may be used.

Alternatively, the feature amount calculation unit 53 may calculate an overlapped area where the probability distribution of the prediction object vehicle and the probability distribution of the ego vehicle overlap; may calculate an area of an union of the probability distribution of the prediction object vehicle and the probability distribution of the ego vehicle; and may calculate a value obtained by dividing the overlapped area by the area of the union, as the overlap degree IoU.

Also about the overlap degree between the prediction object vehicle, and each of the preceding vehicle and the following vehicle of the ego vehicle, the feature amount calculation unit 53 may calculate based on the overlap degree between the probability distribution of the existence position of each vehicle.

### <Calculation of Overlap Degree Considering Intimidating Feeling>

The feature amount calculation unit 53 may calculate the overlap degree IoU, further based on a feature amount regarding an intimidating feeling given to a driver of the other vehicle between the prediction object vehicle and the ego vehicle.

When determining the lane change destination, a driver is influenced by the intimidating feeling of the other vehicle. According to the above configuration, by also considering the feature amount regarding the intimidating feeling for calculation of the overlap degree IoU, the feature of the lane change destination position can be captured with better accuracy.

For example, as shown in FIG. 15, the feature amount calculation unit 53 calculates the feature amount regarding the intimidating feeling, by dividing the vehicle length Lm of the prediction object vehicle by the vehicle length Lego of the ego vehicle. In addition to the vehicle length, vehicle features that give the impression to the driver of the other vehicle, such as the vehicle height, the vehicle type, and the vehicle color, may be considered.

For example, the feature amount calculation unit 53 corrects the overlap degree so that the overlap degree decreases, as the intimidating feeling of the prediction object vehicle with respect to the ego vehicle becomes large, and corrects the overlap degree so that the overlap degree increases, as the intimidating feeling of the ego vehicle with respect to the prediction object vehicle becomes large. As the intimidating feeling of the prediction object vehicle with respect to the ego vehicle increases, the prediction object vehicle has a higher trend to determine the lane change destination without being aware of the overlap degree with the ego vehicle. As the intimidating feeling of the ego vehicle with respect to the prediction object vehicle increases, the prediction object vehicle has a higher trend to determine the lane change destination with being aware of the overlap degree with the ego vehicle. Accordingly, by performing increase and decrease correction of the overlap degree IoU by the feature amount regarding the intimidating feeling, the feature of the change of the lane change destination position can be captured with better accuracy.

### 1-1-4. Lane Change Prediction Unit 54

The lane change prediction unit 54 estimates the lane change destination position of the prediction object vehicle to the ego lane, using a prediction model into which at least one of the position information and the speed information on the prediction object vehicle, and the overlap degree IoU between the ego vehicle and the prediction object vehicle are inputted. In the present embodiment, both of the position information and the speed information on the prediction object vehicle are inputted into the prediction model.

Even if the relative position and the relative speed of the prediction object vehicle with respect to the ego vehicle are the same, the lane change destination position of the prediction object vehicle is changed by the change of the overlap degree IoU between the ego vehicle and the prediction object vehicle. Accordingly, the feature of the change of the lane change destination position can be captured by the overlap degree IoU between the ego vehicle and the prediction object vehicle. According to the above configuration, the lane change destination position of the prediction object vehicle is estimated, using the prediction model into which the overlap degree IoU between the ego vehicle and the prediction object vehicle is inputted in addition to the position information and the speed information on the prediction object vehicle. Accordingly, the prediction accuracy can be improved.

As the position information and the speed information on the prediction object vehicle, the relative position and the relative speed of the prediction object vehicle with respect to the ego vehicle in the longitudinal direction X are inputted.

The lane change destination position of the prediction object vehicle becomes the output of the prediction model. The lane change prediction unit 54 may estimate whether the lane change destination position is the front or the back of the ego vehicle, as the lane change destination position of the prediction object vehicle. The lane change prediction unit 54 may estimate the relative position of the lane change destination position with respect to the ego vehicle, as the lane change destination position of the prediction object vehicle.

In the present embodiment, as the prediction model, a statistical model or a machine learning model which expresses a relation between the position information and the speed information on the prediction object vehicle, the overlap degree IoU between the ego vehicle and the prediction object vehicle, and the lane change destination position is used. The statistical model or the machine learning model is a mathematical model which expresses a statistical relation between the input and the output. The statistical model or the machine learning model is previously learned or designed using data set of a large number of inputs and outputs. The structure and each constant of the prediction model are stored in the storage apparatus, such as EEPROM. The prediction model may be updated using the newly acquired data set.

For example, as the prediction model, various kinds of well-known statistical models or machine learning models, such as SVM (Support Vector Machine), the decision tree, and the neural network, are used. Since various kinds of statistical models or machine learning models are well-known, explanation is omitted.

According to this configuration, only by inputting the position information and the speed information on the prediction object vehicle, and the overlap degree IoU between the ego vehicle and the prediction object vehicle, into the prediction model which uses the statistical model or the machine learning model, and calculating the output of the lane change destination position of the prediction object vehicle, the lane change destination position of the prediction object vehicle which captured the feature of the change of the lane change destination position by the change of the overlap degree IoU can be calculated.

Alternatively, as the prediction model, a rule base model which expresses a relation between the position information and the speed information on the prediction object vehicle, the overlap degree IoU between the ego vehicle and the prediction object vehicle, and the lane change destination position may be used.

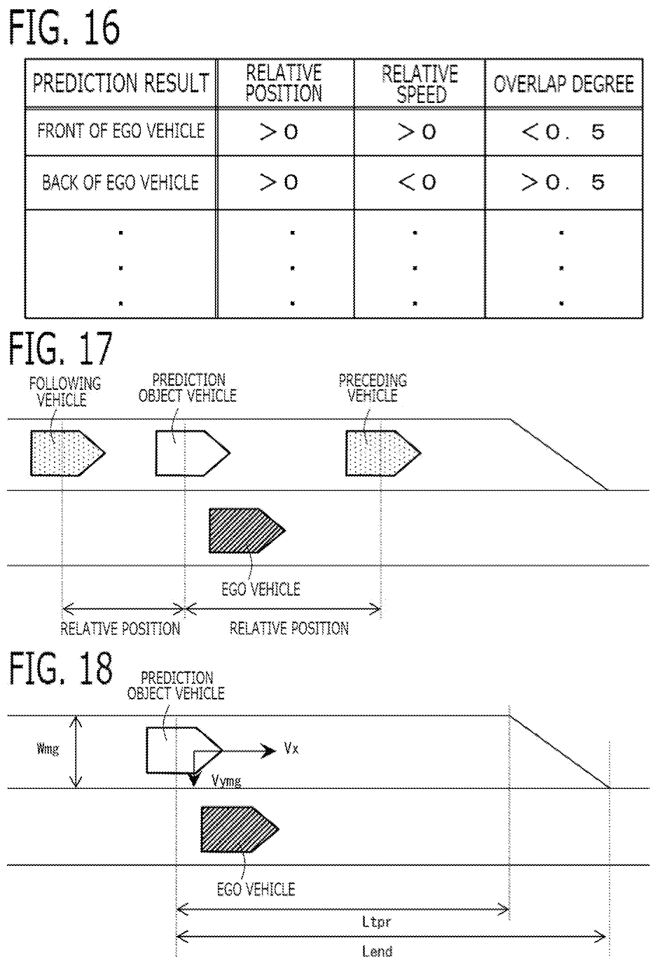

For example, in the rule base model, as shown in FIG. 16, a determination of preliminarily set rules (conditions) is performed based on the position information and the speed information on the prediction object vehicle and the overlap degree IoU between the ego vehicle and the prediction object vehicle, and a lane change destination position which is preliminarily set corresponding to a determination result of each condition is outputted.

Using the prediction model into which one of the position information and the speed information on the prediction object vehicle, and the overlap degree IoU between the ego vehicle and the prediction object vehicle are inputted, the lane change prediction unit 54 may estimate the lane change destination position of the prediction object vehicle to the ego lane. For example, the prediction model into which the speed information on the prediction object vehicle and the overlap degree IoU are inputted may be used. As the relative speed of the prediction object vehicle with respect to the ego vehicle becomes large, and as the overlap degree IoU becomes small, a possibility that the lane change destination position of the prediction object vehicle becomes the front of the ego vehicle becomes high. Or, the prediction model into which the position information on the prediction object vehicle and the overlap degree IoU are inputted may be used. As the position information on the prediction object vehicle with respect to the ego vehicle is away to the front, and as the overlap degree IoU becomes small, the possibility that the lane change destination position of the prediction object vehicle becomes the front of the ego vehicle becomes high.

### <Input of Overlap Degree Between Preceding Vehicle and Following Vehicle of Ego Vehicle>

The lane change prediction unit 54 may estimate the lane change destination position of the prediction object vehicle, using the prediction model into which the position information and the speed information on each of the preceding vehicle and the following vehicle of the ego vehicle, and the overlap degree IoUfr, IoUbk between each of the preceding vehicle and the following vehicle of the ego vehicle, and the prediction object vehicle are further inputted. That is to say, the parameter inputted into the prediction model is increased. Also in this case, the statistical model, the machine learning model, or the rule base model is used for the prediction model.

According to this configuration, as mentioned above, by the overlap degree IoUfr, IoUbk with each of the preceding vehicle and the following vehicle, a feature of whether or not there is a sufficient space between the ego vehicle, and each of the preceding vehicle and the following vehicle for the prediction object vehicle to change lanes can be expressed. Accordingly, even if the overlap degree IoU of the ego vehicle is the same, by capturing the feature of the change of the lane change destination position by the change of the overlap degree IoUfr, IoUbk with each of the preceding vehicle and the following vehicle, the lane change destination position of the prediction object vehicle can be calculated.

As the position information and the speed information on each of the preceding vehicle and the following vehicle, the relative position and the relative speed of each of the preceding vehicle and the following vehicle with respect to the ego vehicle in the longitudinal direction X are inputted.

### 1-1-5. Driving Support Unit 55

The driving support unit 55 performs a driving support of the ego vehicle, based on the prediction result of the lane change destination position of the prediction object vehicle. For example, the driving support unit 55 informs the prediction result of the lane change destination position to the driver via the human interface apparatus 37, such as the loudspeaker and the display screen. The driving support unit 55 increase or decreases the speed of the ego vehicle, based on the prediction result of the lane change destination position. For example, the driving support unit 55 decreases the speed of the ego vehicle, when the estimation position of the lane change destination is the front of the ego vehicle, and increases the speed of the ego vehicle, when the estimation position is the back of the ego vehicle.

The driving support unit 55 determines a target output torque, a target braking force, and the like for increasing or decreasing the speed of the ego vehicle, and transmits these to the power controller, the brake controller, and the like as the drive control apparatus 36. For example, the driving support unit 55 changes the target output torque, the target braking force, and the like by a feedback control and the like so that an actual value approaches a target value, such as the target vehicle distance, the target speed, and the target acceleration. Then, the power controller controls the output torque of the power machines 8, such as the internal combustion engine and the motor, according to the target output torque. The brake controller controls the brake operation of the electric brake apparatus 9 according to the target braking force.

The driving support unit 55 may perform a steering control which changes a target steering angle so that the ego vehicle travels within the ego lane. Alternatively, the driving support unit 55 may generate a target traveling trajectory, and may change the target steering angle so that the ego vehicle travels along with the target traveling trajectory. The driving support unit 55 transmits the target steering angle to the automatic steering controller, and the automatic steering controller controls the electric steering apparatus 7 so that the steering angle follows the target steering angle.

Alternatively, in order to perform higher level automatic driving, the driving support unit 55 may generate a time series target traveling trajectory. The time series target traveling trajectory is a time series traveling plan of a target position, a target traveling direction, a target speed, a target acceleration, and the like of the ego vehicle at each future time. The driving support unit 55 changes the target traveling trajectory, based on the prediction result of the lane change destination position. When increasing the speed of the ego vehicle, the driving support unit 55 increases the target speed and the target acceleration at each future time according to an increase amount of the target speed. The driving support unit 55 controls the vehicle so that the ego vehicle follows the target traveling trajectory. For example, the driving support unit 55 determines the target output torque, the target braking force, the target steering angle, the operation command of the direction indicator, and the like; and transmits each determined command value to the power controller, the brake controller, the automatic steering controller, the light controller, and the like as the drive control apparatus 36.

### <Flowchart>

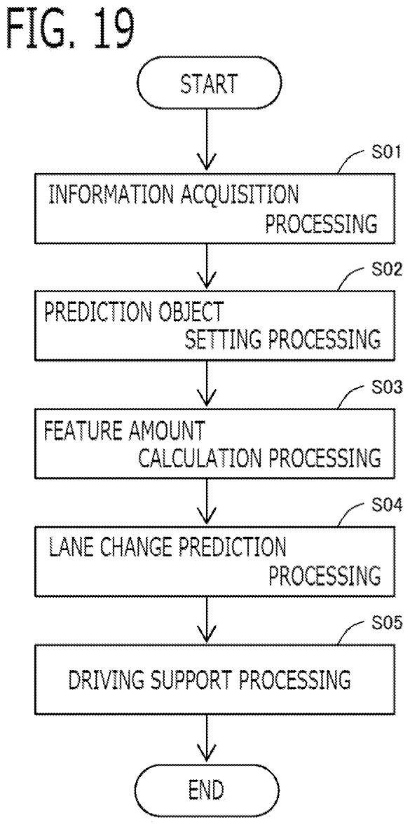

FIG. 19 is a schematic flowchart explaining processing (vehicle behavior prediction method) of the vehicle behavior prediction apparatus 1 according to the present embodiment. Processing of FIG. 19 is executed at every predetermined calculation period, for example.

In the step S01, as mentioned above, the information acquisition unit 51 acquires a periphery state of the ego vehicle, and a traveling state of the ego vehicle; and acquires position information, speed information, and shape information on one or more adjacent vehicles which travel in an adjacent lane adjacent to an ego lane where the ego vehicle is traveling, based on the periphery state and the traveling state of the ego vehicle. The information acquisition unit 51 acquires various kinds of information mentioned above.

In the step S02, as mentioned above, the prediction object setting unit 52 sets the prediction object vehicle from one or more the adjacent vehicles.

In the step S03, as mentioned above, the feature amount calculation unit 53 calculates an overlap degree between the position range of the prediction object vehicle and the position range of the ego vehicle in the longitudinal direction, based on the position information and the shape information on the prediction object vehicle, and the shape information on the ego vehicle. As mentioned above, the feature amount calculation unit 53 calculates the overlap degree between the prediction object vehicle, and each of the preceding vehicle and the following vehicle.

In the step S04, as mentioned above, the lane change prediction unit 54 estimates the lane change destination position of the prediction object vehicle to the ego lane, using a prediction model into which the position information and the speed information on the prediction object vehicle, and the overlap degree between the ego vehicle and the prediction object vehicle are inputted

In the step S05, as mentioned above, the driving support unit 55 performs a driving support of the ego vehicle, based on the prediction result of the lane change destination position of the prediction object vehicle.

### 2. Embodiment 2

Next, the vehicle behavior prediction apparatus 1 according to Embodiment 2 will be explained. The explanation for constituent parts the same as those in Embodiment 1 will be omitted. The basic configuration of the vehicle behavior prediction apparatus 1 according to the present embodiment is the same as Embodiment 1, Embodiment 2 is different from Embodiment 1 in that the feature amounts which are calculated in the feature amount calculation unit 53 and are inputted into the prediction model are added.

Similarly to Embodiment 1, the feature amount calculation unit 53 calculates the overlap degree IoU between the prediction object vehicle and the ego vehicle, and the overlap degree IoU is inputted into the prediction model. Similarly to Embodiment 1, the feature amount calculation unit 53 may calculate the overlap degree IoUfr, IoUbk between the prediction object vehicle, and each of the preceding vehicle and the following vehicle, and the overlap degrees IoUfr, IoUbk may be inputted into the prediction model.

### <Calculation and Input of Collision Possibility Degree>

In the present embodiment, the feature amount calculation unit 53 calculates a collision possibility degree of the prediction object vehicle with respect to each of the preceding vehicle and the following vehicle of the prediction object vehicle, based on the position information and the speed information on the prediction object vehicle, and the position information and the speed information on each of the preceding vehicle and the following vehicle of the prediction object vehicle.

For example, as shown in FIG. 17, the feature amount calculation unit 53 calculates times to collision TTCfr, TTCbk of the prediction object vehicle with respect to each of the preceding vehicle and the following vehicle of the prediction object vehicle, as the collision possibility degree. The feature amount calculation unit 53 calculates the time to collision TTCfr of the prediction object vehicle with respect to the preceding vehicle, by dividing the relative position of the preceding vehicle with respect to the prediction object vehicle, by the relative speed of the preceding vehicle with respect to the prediction object vehicle. The feature amount calculation unit 53 calculates the time to collision TTCbk of the prediction object vehicle with respect to the following vehicle, by dividing the relative position of the following vehicle with respect to the prediction object vehicle, by the relative speed of the following vehicle with respect to the prediction object vehicle.

The lane change prediction unit 54 estimates the lane change destination position of the prediction object vehicle, using the prediction model into which the collision possibility degrees TTCfr, TTCbk of the prediction object vehicle with respect to each of the preceding vehicle and the following vehicle of the prediction object vehicle are further inputted. That is to say, the parameter inputted into the prediction model is increased from Embodiment 1. Also in this case, the statistical model, the machine learning model, or the rule base model is used for the prediction model.

Even if the overlap degree IoU is the same, as the time to collision TTCfr with the preceding vehicle becomes short, in order to avoid the collision with the preceding vehicle, the possibility that the prediction object vehicle changes lanes to the front of the ego vehicle becomes low. Even if the overlap degree IoU is the same, as the time to collision TTCbk with the following vehicle becomes short, in order to avoid the collision with the following vehicle, the possibility that the prediction object vehicle changes lanes to the back of the ego vehicle becomes low. Therefore, even if the overlap degree IoU is the same, by capturing the feature of the change of the lane change destination position by the change of the collision possibility degree TTCfr, TTCbk with each of the preceding vehicle and the following vehicle, the lane change destination position of the prediction object vehicle can be calculated.

### <Calculation and Input of Trend of Acceleration and Deceleration>

In the present embodiment, the feature amount calculation unit 53 calculates a trend of acceleration and deceleration of the prediction object vehicle, based on the speed information of time series on the prediction object vehicle.

For example, the feature amount calculation unit 53 determines a maximum value Vmax and a minimum value Vmin of the speed of the prediction object vehicle in the past determination period, based on the speed information of time series on the prediction object vehicle. Then, as shown in the next equation, the feature amount calculation unit 53 calculates a value obtained by subtracting the minimum value Vmin from the present vehicle speed Vnow of the prediction object vehicle, as a trend of acceleration, and calculates a value obtained by subtracting the maximum value Vmax from the present vehicle speed Vnow of the prediction object vehicle, as a trend of deceleration.

$$Tendency of acceleration = Vnow - V min \qquad ( 4 )$$

$$Tendency of deceleration = Vnow - V max$$

Then, the feature amount calculation unit 53 calculates a larger absolute value or an average value between the trend of acceleration and the trend of deceleration, as the trend of acceleration and deceleration. Or, both of the trend of acceleration and the trend of deceleration may be calculated as the trend of acceleration and deceleration. As the speed information of time series on the prediction object vehicle, the relative speed of time series on the prediction object vehicle with respect to the ego vehicle may be used.

The lane change prediction unit 54 estimates the lane change destination position of the prediction object vehicle, using the prediction model into which the trend of acceleration and deceleration of the prediction object vehicle is inputted further. That is to say, the parameter inputted into the prediction model is increased. Also in this case, the statistical model, the machine learning model, or the rule base model is used for the prediction model.

Even if the overlap degree IoU is the same, as the trend of acceleration becomes large, the possibility that the prediction object vehicle changes lanes to the front of the ego vehicle becomes high. Even if the overlap degree IoU is the same, as the trend of deceleration becomes large, the possibility that the prediction object vehicle changes lanes to the back of the ego vehicle becomes high. Therefore, even if the overlap degree IoU is the same, by capturing the feature of the change of the lane change destination position by the change of the trend of acceleration and deceleration, the lane change destination position of the prediction object vehicle can be calculated.

### <Calculation and Input of Remaining Time to End of Merging Lane>

The information acquisition unit 51 acquires a distance from the adjacent vehicle to an end of the merging lane, when the adjacent lane is the merging lane. The prediction object setting unit 52 sets the adjacent vehicle which is traveling in the merging lane as the prediction object vehicle.

The feature amount calculation unit 53 calculates a remaining time until the prediction object vehicle reaches the end of the merging lane, based on the distance from the prediction object vehicle to the end of the merging lane, and the speed information on the prediction object vehicle.

For example, the feature amount calculation unit 53 calculates the remaining time by dividing the distance from the prediction object vehicle to the end of the merging lane, by the speed of the prediction object vehicle.

Then, the lane change prediction unit 54 estimates the lane change destination position of the prediction object vehicle, using the prediction model into which the remaining time until reaching the end of the merging lane is inputted further. That is to say, the parameter inputted into the prediction model is increased.

The lane change destination position such that lanes are changed after the remaining time has elapsed is no longer estimated, and prediction accuracy can be improved.

### <Calculation and Input of Remaining Time to Forcible Merging Start>

The information acquisition unit 51 acquires the distance from the adjacent vehicle to the end of the merging lane, and the road width information on the merging lane, when the adjacent lane is the merging lane. The prediction object setting unit 52 sets the adjacent vehicle which is traveling in the merging lane as the prediction object vehicle.

The feature amount calculation unit 53 calculates a remaining time until the forcible merging to the ego lane of the prediction object vehicle is required, based on the distance from the prediction object vehicle to the end of the merging lane, the road width information on the merging lane, and the speed information on the prediction object vehicle.

For example, as shown in FIG. 18 and the next equation, the feature amount calculation unit 53 determines a point where the road width of the merging lane starts to decrease, from the road width information on each point of the merging lane; calculates a distance Ltpr from the prediction object vehicle to the decrease start point of road width; and calculates a first remaining time Tmgst1 until the forcible merging start by dividing the distance Ltpr to the decrease start point by the speed Vx of the prediction object vehicle in the longitudinal direction. The feature amount calculation unit 53 calculates a distance Ly in the longitudinal direction which is required until the prediction object vehicle moves from the merging lane to the ego lane in the lateral direction; and calculates a second remaining time Tmgst2 until the forcible merging start, by dividing a distance obtained by subtracting the distance Ly required for movement in the lateral direction from the distance Lend to the end of the merging lane, by the speed Vx of the prediction object vehicle in the longitudinal direction. Then, the feature amount calculation unit 53 calculates either smaller one of the first remaining time Tmgst1 and the second remaining time Tmgst2, as a final remaining time Tmgst until the forcible merging start. Herein, Wmg is the lane width of the merging lane, Vymg is the speed of the prediction object vehicle in the lateral direction at the time of lane change, and is set according to the vehicle type and the present speed of the prediction object vehicle.

$$Tmgst 1 = Ltpr / Vx \qquad ( 5 )$$

$$Ly = Wmg / Vymg \times Vx$$

$$Tmgst 2 = ( Lend - Ly ) / Vx$$

$$Tmgst = MIN ( Tmgst 1 , Tmgst 2 )$$

Then, the lane change prediction unit 54 estimates the lane change destination position of the prediction object vehicle, using the prediction model into which the remaining time Tmgst until the forcible merging start is inputted further. That is to say, the parameter inputted into the prediction model is increased.

The lane change destination position such that lanes is changed after the remaining time Tmgst until the forcible merging start has elapsed is no longer estimated, prediction accuracy can be improved.

All of the collision possibility degree, the trend of acceleration and deceleration, the remaining time to the end of the merging lane, and the remaining time Tmgst until the forcible merging start do not need to be inputted into the prediction model; and any one or more of these may be inputted into the prediction model.

### 3. Embodiment 3

Next, the vehicle behavior prediction apparatus 1 according to Embodiment 3 will be explained. The explanation for constituent parts the same as those in Embodiment 1 will be omitted. The basic configuration of the vehicle behavior prediction apparatus 1 according to the present embodiment is the same as Embodiment 1.

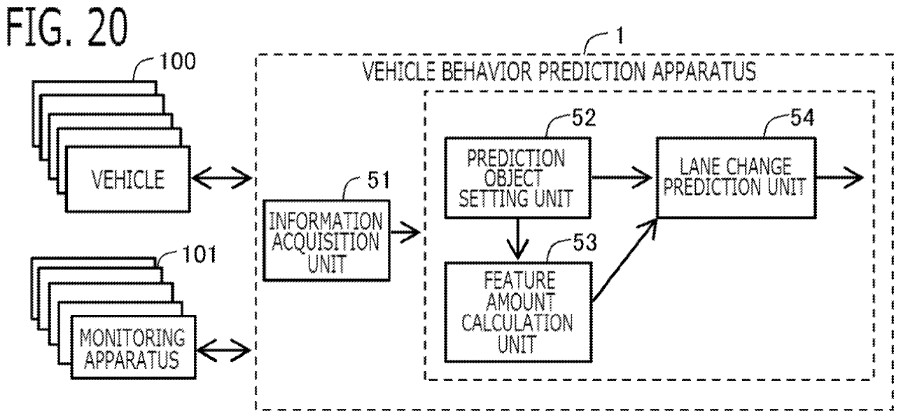

However, in the present embodiment, the object vehicle is set to a specific vehicle which exists within a control area. For example, the vehicle behavior prediction apparatus 1 sets a plurality of control object vehicles which exist in the control area to the object vehicle in order, and performs the vehicle behavior prediction processing about the set object vehicle. The vehicle behavior prediction apparatus 1 is provided in a server connected to the network. Then, the lane change prediction unit 54 transmits the prediction result of the lane change destination position of the prediction object vehicle to the object lane, to the object vehicle. The object vehicle (the driving support unit) performs the driving support of the ego vehicle similar to Embodiment 1, based on the transmitted prediction result of the lane change destination position. The ego vehicle of Embodiment 1 is replaced to the object vehicle, and the ego lane of Embodiment 1 is replaced to the object lane. FIG. 20 shows the schematic block diagram of the vehicle behavior prediction apparatus 1.

The control area may be set to an area of public road, or may be set to an area within various kinds of facility, such as a factory, a distribution center, and a resort facility.

The information acquisition unit 51 acquires the periphery state and the vehicle state which are recognized by each apparatus, via the wireless communication and the wired communication, from a plurality of vehicles 100, monitoring apparatuses 101, such as the roadside machines and the monitoring cameras, and the like which exist in the control area. Then, the periphery state of the object vehicle and the vehicle state of the object vehicle are included in the acquired information. Then, the information acquisition unit 51 acquires the position information, the speed information, and the shape information on the adjacent vehicle which travels in the adjacent lane adjacent to the object lane where the object vehicle is traveling, based on the periphery state of the object vehicle, and the vehicle state of the object vehicle.

Since the processing itself of the prediction object setting unit 52, the feature amount calculation unit 53, the lane change prediction unit 54, and the like is similar to Embodiment 1 or 2, explanation is omitted.

The driving support unit 55 is provided in the vehicle behavior prediction apparatus 1, and the driving support of the object vehicle may be performed via the wireless communication. Since the processing itself of the driving support unit 55 in this case is similar to Embodiment 1, explanation is omitted.

### <Summary of Aspects of the Present Disclosure>

Hereinafter, the aspects of the present disclosure is summarized as appendixes.

### (Appendix 1)

A vehicle behavior prediction apparatus comprising:
an information acquisition unit that acquires a periphery state of an object vehicle and a vehicle state of the object vehicle, and acquires position information, speed information, and shape information on one or more adjacent vehicles which travel in an adjacent lane adjacent to an object lane where the object vehicle is traveling, based on the periphery state and the vehicle state of the object vehicle;
a prediction object setting unit that sets a prediction object vehicle from the one or more adjacent vehicles;
a feature amount calculation unit that calculates an overlap degree between a position range of the prediction object vehicle and a position range of the object vehicle in a longitudinal direction, based on the position information and the shape information on the prediction object vehicle, and shape information included in the vehicle state of the object vehicle; and
a lane change prediction unit that estimates a lane change destination position of the prediction object vehicle to the object lane, using a prediction model into which at least one of the position information and the speed information on the prediction object vehicle, and the overlap degree between the object vehicle and the prediction object vehicle are inputted.

### (Appendix 2)

The vehicle behavior prediction apparatus according to appendix 1,
wherein the prediction model is a statistical model or a machine learning model which expresses a relation between at least one of the position information and the speed information on the prediction object vehicle and the overlap degree between the object vehicle and the prediction object vehicle, and the lane change destination position.

### (Appendix 3)

The vehicle behavior prediction apparatus according to appendix 1 or 2,
wherein the information acquisition unit determines whether or not the adjacent lane where the adjacent vehicle is traveling is a merging lane which merges into the object lane, based on the periphery state, and
wherein the prediction object setting unit sets the adjacent vehicle which is traveling in the merging lane as the prediction object vehicle, when the adjacent lane is the merging lane.

### (Appendix 4)

The vehicle behavior prediction apparatus according to any one of appendixes 1 to 3,
wherein the feature amount calculation unit calculates the overlap degree, based on an overlap length of position range where a position range of the prediction object vehicle and a position range of the object vehicle overlap in the longitudinal direction, and a length of a union of the position range of the prediction object vehicle and the position range of the object vehicle.

### (Appendix 5)

The vehicle behavior prediction apparatus according to any one of appendixes 1 to 4,
wherein the information acquisition unit acquires position information, speed information, and shape information on each of a preceding vehicle and a following vehicle which are traveling in the object lane in front of and in back of the object vehicle, based on the periphery state and the vehicle state of the object vehicle,
wherein the feature amount calculation unit calculates an overlap degree between the position range of the prediction object vehicle and a position range of each of the preceding vehicle and the following vehicle, based on the position information and the shape information on the prediction object vehicle, and the position information and the shape information on each of the preceding vehicle and the following vehicle of the object vehicle, and
wherein the lane change prediction unit estimates the lane change destination position of the prediction object vehicle, using the prediction model into which at least one of the position information and the speed information on each of the preceding vehicle and the following vehicle of the object vehicle, and the overlap degree between each of the preceding vehicle and the following vehicle of the object vehicle and the prediction object vehicle are further inputted.

### (Appendix 6)

The vehicle behavior prediction apparatus according to any one of appendixes 1 to 5,
wherein the information acquisition unit acquires position information and speed information on each of a preceding vehicle and a following vehicle which are traveling in the adjacent lane in front of and in back of the prediction object vehicle, based on the periphery state and the vehicle state of the object vehicle,
wherein the feature amount calculation unit calculates a collision possibility degree of the prediction object vehicle to each of the preceding vehicle and the following vehicle of the prediction object vehicle, based on the position information and the speed information on the prediction object vehicle, and the position information and the speed information on each of the preceding vehicle and the following vehicle of the prediction object vehicle, and
wherein the lane change prediction unit estimates the lane change destination position of the prediction object vehicle, using the prediction model into which the collision possibility degree of the prediction object vehicle to each of the preceding vehicle and the following vehicle of the prediction object vehicle is further inputted.

### (Appendix 7)

The vehicle behavior prediction apparatus according to any one of appendixes 1 to 6,
wherein the information acquisition unit determines whether or not the adjacent lane where the adjacent vehicle is traveling is a merging lane which merges into the object lane, based on the periphery state; and acquires a distance from the adjacent vehicle to an end of the merging lane, when the adjacent lane is the merging lane,
wherein the prediction object setting unit sets the adjacent vehicle which is traveling in the merging lane, as the prediction object vehicle, when the adjacent lane is the merging lane,
wherein the feature amount calculation unit calculates a remaining time until the prediction object vehicle reaches the end of the merging lane, based on the distance to the end of the merging lane, and the speed information of the prediction object vehicle, and
wherein the lane change prediction unit estimates the lane change destination position of the prediction object vehicle, using the prediction model into which the remaining time until reaching the end of the merging lane is further inputted.

### (Appendix 8)

The vehicle behavior prediction apparatus according to any one of appendixes 1 to 7,
wherein the information acquisition unit determines whether or not the adjacent lane where the adjacent vehicle is traveling is a merging lane which merges into the object lane, based on the periphery state; and acquires a distance from the adjacent vehicle to an end of the merging lane, and a road width information on the merging lane, when the adjacent lane is the merging lane,
wherein the prediction object setting unit sets the adjacent vehicle which is traveling in the merging lane, as the prediction object vehicle, when the adjacent lane is the merging lane,
wherein the feature amount calculation unit calculates a remaining time until a forcible merging to the object lane of the prediction object vehicle is required, based on the distance to the end of the merging lane, the road width information on the merging lane, and the speed information on the prediction object vehicle, and
wherein the lane change prediction unit estimates the lane change destination position of the prediction object vehicle, using the prediction model into which the remaining time until starting the forcible merging is further inputted.

### (Appendix 9)

The vehicle behavior prediction apparatus according to any one of appendixes 1 to 8,
wherein the feature amount calculation unit calculates a trend of acceleration and deceleration of the prediction object vehicle, based on the speed information of time series of the prediction object vehicle, and
wherein the lane change prediction unit estimates the lane change destination position of the prediction object vehicle, using the prediction model into which the trend of acceleration and deceleration of the prediction object vehicle is inputted further.

### (Appendix 10)

The vehicle behavior prediction apparatus according to any one of appendixes 1 to 9,
wherein the feature amount calculation unit virtually increases a position range of each vehicle and a vehicle length of each vehicle which are used for calculation of the overlap degree, based on a safe distance to be secured at minimum in front and back of vehicle.

### (Appendix 11)

The vehicle behavior prediction apparatus according to any one of appendixes 1 to 10,
wherein the feature amount calculation unit sets the overlap degree to a preliminarily set value, when a position range of the prediction object vehicle completely includes a position range of the object vehicle, or when the position range of the object vehicle completely includes the position range of the prediction object vehicle.

### (Appendix 12)

The vehicle behavior prediction apparatus according to any one of appendixes 1 to 3,
wherein the feature amount calculation unit calculates a probability distribution of presence of the prediction object vehicle with respect to the longitudinal direction, as the position range of the prediction object vehicle;
calculates a probability distribution of presence of the object vehicle with respect to the longitudinal direction, as the position range of the object vehicle; and
calculates the overlap degree, based on an overlap degree between the probability distribution of the prediction object vehicle, and the probability distribution of the object vehicle.

### (Appendix 13)

The vehicle behavior prediction apparatus according to any one of appendixes 1 to 12,
wherein the feature amount calculation unit calculates the overlap degree, further based on a feature amount regarding an intimidating feeling given to a driver of the other vehicle between the prediction object vehicle and the object vehicle.

### (Appendix 14)

The vehicle behavior prediction apparatus according to any one of appendixes 1 to 13,
wherein the information acquisition unit acquires a vehicle length of the prediction object vehicle, and a vehicle type of the prediction object vehicle; and when a difference between the acquired vehicle length of the prediction object vehicle and a vehicle length estimated from the vehicle type of the prediction object vehicle is greater than or equal to a determination value, sets the vehicle length estimated from the vehicle type of the prediction object vehicle as a formal vehicle length of the prediction object vehicle used for calculation of the overlap degree.

### (Appendix 15)

A vehicle behavior prediction method comprising:
an information acquisition step of acquiring a periphery state of an object vehicle and a vehicle state of the object vehicle, and acquiring position information, speed information, and shape information on one or more adjacent vehicles which travel in an adjacent lane adjacent to an object lane where the object vehicle is traveling, based on the periphery state and the vehicle state of the object vehicle;
a prediction object setting step of setting a prediction object vehicle from the one or more adjacent vehicles;
a feature amount calculation step of calculating an overlap degree between a position range of the prediction object vehicle and a position range of the object vehicle in a longitudinal direction, based on the position information and the shape information on the prediction object vehicle, and shape information included in the vehicle state of the object vehicle; and
a lane change prediction step of estimating a lane change destination position of the prediction object vehicle to the object lane, using a prediction model into which at least one of the position information and the speed information on the prediction object vehicle, and the overlap degree between the object vehicle and the prediction object vehicle are inputted.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A vehicle behavior prediction apparatus comprising at least one processor configured to implement:
an information acquisitor that acquires a periphery state of an object vehicle and a vehicle state of the object vehicle, and acquires position information, speed information, and shape information on one or more adjacent vehicles which travel in an adjacent lane adjacent to an object lane where the object vehicle is traveling, based on the periphery state and the vehicle state of the object vehicle;
a prediction object setter that sets a prediction object vehicle from the one or more adjacent vehicles;
a feature amount calculator that calculates an overlap degree between a position range of the prediction object vehicle and a position range of the object vehicle in a longitudinal direction, based on the position information and the shape information on the prediction object vehicle, and shape information included in the vehicle state of the object vehicle; and
a lane change predictor that estimates a lane change destination position of the prediction object vehicle to the object lane, using a prediction model into which at least one of the position information and the speed information on the prediction object vehicle, and the overlap degree between the object vehicle and the prediction object vehicle are inputted.

2. The vehicle behavior prediction apparatus according to claim 1,
wherein the prediction model is a statistical model or a machine learning model which expresses a relation between at least one of the position information and the speed information on the prediction object vehicle and the overlap degree between the object vehicle and the prediction object vehicle, and the lane change destination position.

3. The vehicle behavior prediction apparatus according to claim 1,
wherein the information acquisitor determines whether or not the adjacent lane where the adjacent vehicle is traveling is a merging lane which merges into the object lane, based on the periphery state, and
wherein the prediction object setter sets the adjacent vehicle which is traveling in the merging lane as the prediction object vehicle, when the adjacent lane is the merging lane.

4. The vehicle behavior prediction apparatus according to claim 1,
wherein the feature amount calculator calculates the overlap degree, based on an overlap length of position range where a position range of the prediction object vehicle and a position range of the object vehicle overlap in the longitudinal direction, and a length of a union of the position range of the prediction object vehicle and the position range of the object vehicle.

5. The vehicle behavior prediction apparatus according to claim 1,
wherein the information acquisitor acquires position information, speed information, and shape information on each of a preceding vehicle and a following vehicle which are traveling in the object lane in front of and in back of the object vehicle, based on the periphery state and the vehicle state of the object vehicle,
wherein the feature amount calculator calculates an overlap degree between the position range of the prediction object vehicle and a position range of each of the preceding vehicle and the following vehicle, based on the position information and the shape information on the prediction object vehicle, and the position information and the shape information on each of the preceding vehicle and the following vehicle of the object vehicle, and
wherein the lane change predictor estimates the lane change destination position of the prediction object vehicle, using the prediction model into which at least one of the position information and the speed information on each of the preceding vehicle and the following vehicle of the object vehicle, and the overlap degree between each of the preceding vehicle and the following vehicle of the object vehicle and the prediction object vehicle are further inputted.

6. The vehicle behavior prediction apparatus according to claim 1,
wherein the information acquisitor acquires position information and speed information on each of a preceding vehicle and a following vehicle which are traveling in the adjacent lane in front of and in back of the prediction object vehicle, based on the periphery state and the vehicle state of the object vehicle,
wherein the feature amount calculator calculates a collision possibility degree of the prediction object vehicle to each of the preceding vehicle and the following vehicle of the prediction object vehicle, based on the position information and the speed information on the prediction object vehicle, and the position information and the speed information on each of the preceding vehicle and the following vehicle of the prediction object vehicle, and
wherein the lane change predictor estimates the lane change destination position of the prediction object vehicle, using the prediction model into which the collision possibility degree of the prediction object vehicle to each of the preceding vehicle and the following vehicle of the prediction object vehicle is further inputted.

7. The vehicle behavior prediction apparatus according to claim 1,
wherein the information acquisitor determines whether or not the adjacent lane where the adjacent vehicle is traveling is a merging lane which merges into the object lane, based on the periphery state; and acquires a distance from the adjacent vehicle to an end of the merging lane, when the adjacent lane is the merging lane,
wherein the prediction object setter sets the adjacent vehicle which is traveling in the merging lane, as the prediction object vehicle, when the adjacent lane is the merging lane,
wherein the feature amount calculator calculates a remaining time until the prediction object vehicle reaches the end of the merging lane, based on the distance to the end of the merging lane, and the speed information of the prediction object vehicle, and
wherein the lane change predictor estimates the lane change destination position of the prediction object vehicle, using the prediction model into which the remaining time until reaching the end of the merging lane is further inputted.

8. The vehicle behavior prediction apparatus according to claim 1,
wherein the information acquisitor determines whether or not the adjacent lane where the adjacent vehicle is traveling is a merging lane which merges into the object lane, based on the periphery state; and acquires a distance from the adjacent vehicle to an end of the merging lane, and a road width information on the merging lane, when the adjacent lane is the merging lane,
wherein the prediction object setter sets the adjacent vehicle which is traveling in the merging lane, as the prediction object vehicle, when the adjacent lane is the merging lane,
wherein the feature amount calculator calculates a remaining time until a forcible merging to the object lane of the prediction object vehicle is required, based on the distance to the end of the merging lane, the road width information on the merging lane, and the speed information on the prediction object vehicle, and
wherein the lane change predictor estimates the lane change destination position of the prediction object vehicle, using the prediction model into which the remaining time until starting the forcible merging is further inputted.

9. The vehicle behavior prediction apparatus according to claim 1,
wherein the feature amount calculator calculates a trend of acceleration and deceleration of the prediction object vehicle, based on the speed information of time series of the prediction object vehicle, and
wherein the lane change predictor estimates the lane change destination position of the prediction object vehicle, using the prediction model into which the trend of acceleration and deceleration of the prediction object vehicle is inputted further.

10. The vehicle behavior prediction apparatus according to claim 1,
wherein the feature amount calculator virtually increases a position range of each vehicle and a vehicle length of each vehicle which are used for calculation of the overlap degree, based on a safe distance to be secured at minimum in front and back of vehicle.

11. The vehicle behavior prediction apparatus according to claim 1,
wherein the feature amount calculator sets the overlap degree to a preliminarily set value, when a position range of the prediction object vehicle completely includes a position range of the object vehicle, or when the position range of the object vehicle completely includes the position range of the prediction object vehicle.

12. The vehicle behavior prediction apparatus according to claim 1,
wherein the feature amount calculator calculates a probability distribution of presence of the prediction object vehicle with respect to the longitudinal direction, as the position range of the prediction object vehicle;
calculates a probability distribution of presence of the object vehicle with respect to the longitudinal direction, as the position range of the object vehicle; and
calculates the overlap degree, based on an overlap degree between the probability distribution of the prediction object vehicle, and the probability distribution of the object vehicle.

13. The vehicle behavior prediction apparatus according to claim 1,
wherein the feature amount calculator calculates the overlap degree, further based on a feature amount regarding an intimidating feeling given to a driver of the other vehicle between the prediction object vehicle and the object vehicle.

14. The vehicle behavior prediction apparatus according to claim 1,
wherein the information acquisitor acquires a vehicle length of the prediction object vehicle, and a vehicle type of the prediction object vehicle; and
when a difference between the acquired vehicle length of the prediction object vehicle and a vehicle length estimated from the vehicle type of the prediction object vehicle is greater than or equal to a determination value, sets the vehicle length estimated from the vehicle type of the prediction object vehicle as a formal vehicle length of the prediction object vehicle used for calculation of the overlap degree.

15. A vehicle behavior prediction method comprising:
acquiring a periphery state of an object vehicle and a vehicle state of the object vehicle, and acquiring position information, speed information, and shape information on one or more adjacent vehicles which travel in an adjacent lane adjacent to an object lane where the object vehicle is traveling, based on the periphery state and the vehicle state of the object vehicle;
setting a prediction object vehicle from the one or more adjacent vehicles;
calculating an overlap degree between a position range of the prediction object vehicle and a position range of the object vehicle in a longitudinal direction, based on the position information and the shape information on the prediction object vehicle, and shape information included in the vehicle state of the object vehicle; and
estimating a lane change destination position of the prediction object vehicle to the object lane, using a prediction model into which at least one of the position information and the speed information on the prediction object vehicle, and the overlap degree between the object vehicle and the prediction object vehicle are inputted.
